(19) United States
(12) Patent Application Publication
(10) Pub. No.: US 2026/0146560 A1
(43) Pub. Date: May 28, 2026

(54) METHOD AND COMPUTER PROGRAM FOR DETECTING SURGE EVENTS IN A TURBINE ENGINE

(71) Applicant: Airbus Operations S.L.U., Madrid (ES)

(72) Inventors: Alberto MARTINEZ SANCHO, Madrid (ES); Pedro Felipe RAMOS PAUL DE LA LASTRA, Madrid (ES)

(21) Appl. No.: 19/394,545

(22) Filed: Nov. 19, 2025

(30) Foreign Application Priority Data
Nov. 22, 2024 (EP) 24383267

(51) Int. Cl. F02C 7/057; B64D 41/00; B64D 45/00; F02C 9/28; G01K 3/00; G01K 3/08; G01K 13/024; G01M 15/14; G08B 21/18

(52) U.S. Cl. CPC F02C 7/057; F02C 9/28; G01K 3/005; G01K 3/08; G01K 13/024; G01M 15/14; G08B 21/182; B64D 41/00; B64D 45/00; F05D 2270/101

(57) ABSTRACT

A method for detecting surge events in a turbine engine before impediment of the operation of a turbine engine, based on the exhaust gas temperature and its variation in time, as well as based on the engine speed rotation, so as to trigger an alert signal in case certain conditions are met, such that surge of the engine may be anticipated, detected and in some cases avoided.

### RELATED APPLICATION

This application incorporates by reference and claims priority to European patent application EP24383267, filed Nov. 22, 2024.

### TECHNICAL FIELD

The invention relates to a method implement such to detect surge situations in a gas turbine engine, particularly in a turbine engine core compressor which feeds the engine with compressed air.

### BACKGROUND

Surge events in a gas turbine engine correspond to a situation in which the flow of gas normally happening in the engine from an intake to an exhaust is disturbed. More particularly in the event of a surge, there may be no flow of gas or even a reversed flow of gas in the compressor. Surge events may damage the engine and result in the engine requiring maintenance which includes out of service time for the engine and associated costs. A surge event may also cause the controller for the engine to suddenly shut the engine down, which impacts the operation of the aircraft.

A surge event may occur when the engine intakes sand or dust, which can clog or obstruct flow passages in the engine. For example, the combustor in the engine may be clogged with sand or dust which degrades the combustion in the combustion chamber. Degradation of combustion can lead to surge events in the core compressor of the engine.

An early detection of surge events is beneficial as it may allow the engine to be switched off or otherwise adjusted before the surge event causes the engine operation to significantly deteriorate and allows for planning of a light maintenance operation to restore the engine to full functionality. The availability of the whole aircraft may thus be improved as it would be minimally impacted by surge events in the engine. Also, an early detection or anticipation of a surge event increases safety of the aircraft because the engine will undergo a maintenance operation instead of being confronted with an unexpected automatic shutdown of the engine at a later stage.

Conventional methods to detect surge in a load compressor are implemented by the controller of the engine, which may be an auxiliary power unit (APU) of an aircraft. These methods detect the surge event at stage of the event where the surge is strongly affecting the engine and may be sufficient to cause the controller to shut down the engine.

### SUMMARY

The method may particularly be applied to turbine engines in auxiliary power units (APU) in aircrafts.

The invention may be embodied as a method to surges in the core compressor of a gas turbine engine, such as an engine for an APU. The method may detect surges of low severity in the engine. A benefit of the method is to reduce maintenance costs and periods during which the engine is out of service for maintenance by reducing damaging effects of a strong surge in an engine.

The invention also aims to propose a method which increases safety of the aircraft as the occurrence or possibility of occurrence of a surge event may be signaled early to the maintenance team such that automatic shutdown of the engine in consecutive flights may be avoided.

The invention proposes a method for identifying surge events in a turbine engine comprising:
a. obtaining temperature values of exhaust gases of the engine at multiple instants during the operation of the engine,
b. obtaining values of a temperature variation indicator based on the exhaust gases' temperature values,
c. if, at a given instant, a first criteria and a second criteria are met, the first criteria including at least one temperature value above a predetermined exhaust temperature threshold, and a second criteria including at least one value of the temperature variation indicator above a first predetermined temperature variation threshold, then:
c i. defining a monitoring interval extending from the first instant of the first criteria and the second criteria being met, for as long as the first criteria and the second criteria are consecutively met,
c ii. obtaining a set of values of a rotation speed of a shaft of the engine during the monitoring interval, determining the minimum value in this set of values, and comparing this minimum speed value to a first predetermined speed threshold, and
c iii. obtaining a set of values of the temperature of exhaust gases during the monitoring interval, calculating a temperature gap between the highest temperature value in this set of values and the lowest temperature value in this set of values, and comparing this temperature gap with a first predetermined temperature gap threshold, and

d. if, in at least two separate monitoring intervals, the minimum speed value is below said first predetermined speed threshold and the temperature gap is above said predetermined temperature gap threshold, triggering an alert signal.

The method applies to detecting surges in a core compressor of the gas turbine engine. The core compressor is the compressor that directly feeds the combustor of the engine with compressed air. The core compressor has a different function from a load compressor. A load compressor is a compressor that uses the mechanical energy of the engine to produce pneumatic energy dedicated to systems in the aircraft other than the engine such as compressed air for cabin pressurization.

Beneficially the temperature of the exhaust gases of the engine are measured during the entire operation phase of the engine.

The minimal duration of the monitoring interval may be the duration between two consecutive temperature measurements. This would be the case when the first criteria and the second criteria are only met at a single instant. The temperature variation indicator may be a derivation calculation based on the difference between two consecutive values of temperature divided by the time elapsed between the two measurements.

The alert signal may be a signal to a computer, for example an engine controller or to an auto-pilot computer for the aircraft. For example, the alert signal may cause the engine controller to adjust the fuel flow to the combustor, reduce the load being driven by the load compressor or adjust inlet guide vanes on the gas turbine. The adjustments are made to shift the operational conditions of the gas turbine away from the conditions which are a precursor of a surge or of a surge. The alert signal may also be a message to a human, such as an alphanumeric message or a pilot light to a pilot, to a maintenance team or to a maintenance software for example.

The alert signal may be used by a controller of the engine to actuate technical effects in the operation of the engine such as modifying operation conditions of the engine.

Obtaining values may represent steps of measuring and storing data representative of these values. This is particularly the case if the invention is implemented while the engine is operating.

Obtaining values may also represent steps of retrieving data representative of these values from a memory. This may particularly be the case if the invention is implemented after an operating phase of the engine. For example, in the case of an aircraft this may be the case if the data is analyzed after the aircraft has landed following a flight.

Sub-steps i), ii) and iii) of step c) are only triggered if the first criteria and the second criteria are met at the same time. Similarly, the monitoring interval as defined in sub-step i) extends for as many consecutive datapoints at which the first criteria and the second criteria are simultaneously met.

In some embodiments of the invention, an alert signal is triggered only if the minimum speed value is below said first predetermined speed threshold and the temperature gap is above said predetermined temperature gap threshold, in two consecutive extended intervals. The detection of the two conditions in isolated extended intervals may be false positives in some conditions and be, in other conditions, the sign of a precursor to a surge or of a surge in the engine. The detection of these two conditions in two consecutive extended intervals represent the precursor of a surge or a surge in the engine. In some embodiments of the invention, it may be elected to ignore the detection of the two conditions happening in two separate non-consecutive intervals. For example, when the two conditions happen in intervals that are very separated from each other in time, the conditions may be ignored as indicating a surge. In these embodiments, an alert signal is triggered when the two conditions happen in two consecutive extended intervals.

In some embodiments of the invention, alert signals are triggered as long as the conditions are met in two consecutive monitoring intervals. As a consequence, in such embodiments, if the conditions are met in three consecutive separate monitoring intervals, two consecutive alert signals will be triggered.

In some embodiments of the invention, step c) is implemented only if the temperature variation indicator is also below a second predetermined temperature variation threshold.

Therefore, the implementation of sub-steps i), ii), and iii) of step c are conditioned to a third criteria, additionally to the first criteria and the second criteria. This third criteria may allow to filter out erroneous values of the temperature variation indicator.

In such embodiments, the analysis of the speed rotation of the engine's shaft and of the temperature gap during a monitoring interval is thus only implemented if, during said monitoring interval: at least one temperature value is above a predetermined exhaust temperature threshold, and at least one value of the temperature variation indicator is above the first predetermined temperature variation threshold and below the second predetermined temperature variation threshold.

In some embodiments of the invention, in step c), the monitoring interval is extended to also comprise a time interval situated right before the first instant of this monitoring interval at which the first criteria and the second criteria are met.

Such monitoring interval to which time has been added either before the first occurrence of the first criteria and the second criteria, and/or after the last consecutive occurrence of the first criteria and the second criteria is called extended interval.

A method of the invention thereby comprises a step of defining an extended time interval, called extended interval, comprising the original monitoring interval during which the first criteria and the second criteria are continuously met, said extended interval having a longer duration than the duration of said monitoring interval.

By right before it is meant before and continuous with, such that the extended interval is one uninterrupted time interval which comprises moments before the monitoring interval as well as the monitoring interval.

Indeed, in a method of the invention, only the exhaust temperature and temperature variation are monitored actively during the whole operation of the engine. However, upon detection of abnormal values for these variables in a short duration, these and other variables are further investigated in moments happening before and/or after this first indication of a possible surge in order to confirm if a surge is indeed happening or not.

In some embodiments of the invention, in step c), the monitoring interval is extended to also comprise a time interval situated right after the last consecutive occurrence of the first criteria and the second criteria being met in this monitoring interval.

By right after it is meant after and continuous with, such that the extended interval is one uninterrupted time interval which comprises moments after the monitoring interval as well as the monitoring interval.

In other embodiments, the extended interval may comprise time intervals situated both right before and right after the monitoring interval, such that the extended interval represents an extension of the monitoring interval before and after the original monitoring interval.

The monitoring interval may be extended by between 2 and 30 seconds, for example by 10 seconds.

The extended interval may for example comprise 5 seconds before the monitoring interval and 5 seconds after before the monitoring interval.

In some embodiments of the invention, in step d), the alert signal is triggered only if the minimum speed value is also above a second predetermined speed threshold.

Thus, to trigger an alarm signal in step d), the conditions to be met are: the minimum speed value is below the first predetermined speed threshold and above the second predetermined speed threshold, and the temperature gap is above the predetermined temperature gap threshold.

This third condition may allow to filter out erroneous values of the minimum engine speed.

A method according to the invention may be implemented as computer-implemented method. In particular the method may be implemented by a computer, a controller, or any equivalent device.

In particular the invention extends to a computer-implemented method for identifying surge events in a turbine engine comprising:
obtaining temperature values of exhaust gases of the engine at multiple instants during the operation of the engine,
obtaining values of a temperature variation indicator based on the exhaust gases' temperature values,
if, at a given instant, a first criteria and a second criteria are met, the first criteria consisting of at least one temperature value being above a predetermined exhaust temperature threshold, and a second criteria consisting of at least one value of the temperature variation indicator being above a first predetermined temperature variation threshold, then defining a monitoring interval extending: from the first instant of the first criteria and the second criteria being met, and for as long as the first criteria and the second criteria are consecutively met, obtaining a set of values of a rotation speed of a shaft of the engine during the monitoring interval, determining the minimum value in this set of values, and comparing this minimum speed value to a first predetermined speed threshold, and obtaining a set of values of the temperature of exhaust gases during the monitoring interval, calculating a temperature gap between the highest temperature value in this set of values and the lowest temperature value in this set of values, and comparing this temperature gap with a first predetermined temperature gap threshold,
if, in at least two separate monitoring intervals, the minimum speed value is below said first predetermined speed threshold and the temperature gap is above said predetermined temperature gap threshold, triggering an alert signal and/or actuating the engine or a component of the engine to suppress or avoid a surge condition.

In particular, obtaining a set of values of a rotation speed of a shaft of the engine and obtaining a set of values of the temperature of exhaust gases of the engine may comprise retrieving values from a memory.

In the present invention, values may be retrieved from any memory to which the computer has access.

In particular when the method is implemented during the operation of the engine and the extended interval extends before the monitoring interval, values stored in a memory must be retrieved. When the extended interval extends after the monitoring interval, values may be collected directly from measurement and used for processing and/or saved in a memory.

Furthermore, in some embodiments, each time the minimum speed value is below said predetermined speed threshold and the temperature gap is above said predetermined temperature gap threshold, a counter is incremented if its value is below 2, and when the value of the counter reaches 2 the alert signal is triggered and the counter is reset to zero.

The counter may be reset to zero each time there is an extended interval not meeting the two conditions, such that an alert is triggered only when the two conditions are met in two consecutive extended intervals.

To do so, each time the minimum speed value is above said predetermined speed threshold or the temperature gap is below said predetermined temperature gap threshold during the whole monitoring interval, the counter is reset to zero.

The invention also extends to a computer program comprising instructions for implementing a method of the invention when said program is run on a computer.

The invention also extends to other possible combinations of features described in the above description and in the following description relative to the figures. In particular, the invention extends to methods comprising features described in relation to the computer-implement methods and/or the computer program; the invention extends to computer program comprising features described in relation to the methods and/or the computer-implement methods; the invention extends to computer-implement methods comprising features described in relation to the methods and/or the computer program.

### SUMMARY OF DRAWING

Some specific exemplary embodiments and aspects of the invention are described in the following description in reference to the accompanying figure.

FIG. 1 is a schematic representation of a method embodiment according to the invention.

FIG. 2 is a schematic diagram of an auxiliary power unit in an aircraft.

### DETAILED DESCRIPTION

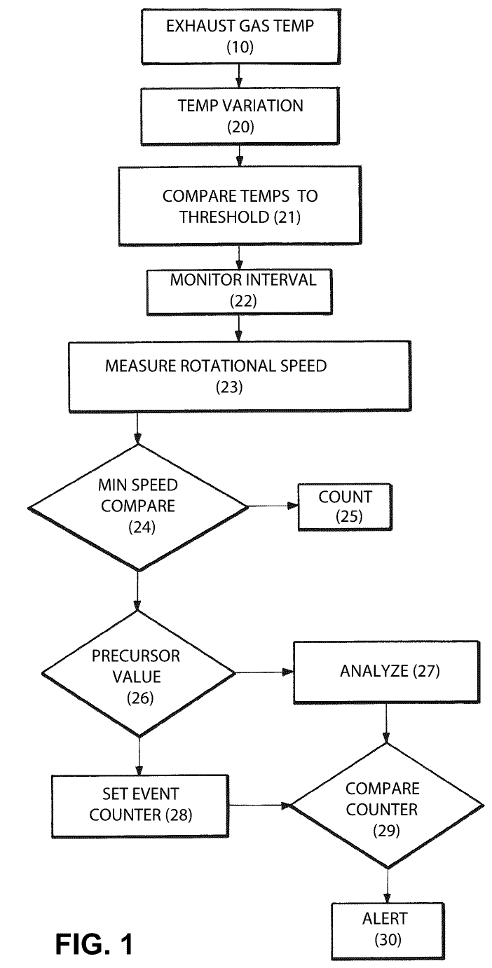

In FIG. 1, logical steps of a method according to the invention are depicted.

The temperature of exhaust gases of a combustion turbine engine, e.g. gas turbine, are continuously measured in a step 10, to obtain exhaust gases temperature values. The temperature values may be obtained by measuring temperature at one location, or it may be obtained by calculating an average of various temperature values obtained at different locations of the engine and/or engine exhaust. These temperature values are stored in a memory during the operation of the engine and are retrieved from this memory to perform the following steps of the method described herein.

The rotational speed of a shaft of the engine is also measured continuously and the values of the rotational speeds are stored in a memory. The shaft is the main shaft of the engine. In particular the shaft is the low-pressure shaft (or low-pressure spool shaft) of the engine. The values of the shaft rotation speed are stored in a memory during the operation of the engine and are retrieved from this memory to perform the following steps of a method according to the invention.

In a first step 20, a temperature variation indicator is calculated based on the temperature values of exhaust gases. In particular, the calculation may be a simple difference between two successive temperature values. The calculation is beneficially made for two successive temperature values measured. The temperature variation indicator may be compared to a derivative value of the temperature of exhaust gases given that the temperature measurement frequency is usually high.

In a second step 21, the temperature values measured are compared to a predetermined exhaust temperature threshold. For example, in an aircraft APU, the temperature values may be compared with a threshold of more than 400 degrees Celsius.

In this second step 21, the temperature variation indicator calculated with the temperature value compared in this same step 21, is also compared to a first predetermined temperature variation threshold and a second predetermined temperature variation threshold to determine whether it is between these two threshold values. This allows to filter out any monitoring intervals in which the temperature variation indicator is very low or very high, representing a measurement error.

Further steps of a method according to the invention are only implemented if, at at least one instant, both the first criteria (at least one temperature value is above a predetermined threshold) and the second criteria (the derivative value of the temperature is within a predetermined range) are met.

As soon as a pair of value for temperature and temperature variation indicator of a same instant meet respectively the first criteria and the second criteria, step 22 is implemented.

In step 22, a monitoring interval is defined. In this embodiment the monitoring interval is an extended interval comprises a time interval situated right before the first instant of this monitoring interval at which the first criteria and the second criteria are met, as well as a time interval situated right after the last consecutive instant for which the criteria and the second criteria are met. It may be, in some cases that there only exist one instant at which a pair of temperature and temperature variation indicator meet respectively the first criteria and the second criteria such that the monitoring interval will be very short. In other cases, such conditions will be met for multiple consecutive instants (or measure points) thereby defining the duration of the monitoring interval and by extension of the extended interval.

The extended interval may comprise some seconds before the monitoring interval and some second after the monitoring interval.

The program for implementing a method of the invention comprises a defined precursor variable. This precursor variable may take two values, such as for example ‘true’ or ‘false’ values.

In step 23, the temperatures measured during the extended interval are processed to calculate a temperature gap between the highest temperature value in this set of temperature values and the lowest temperature value in this set of temperature values. Previously to calculating this temperature gap, a filter may have been applied to the temperature values in order to exclude very extreme temperature values that could only result as errors of the temperature measurement.

Also in step 23, the rotation speed values of a shaft of the engine measured during the extended interval are processed to determine the minimum value in this set of rotation speed values.

In following step 24, the minimum speed value is compared to a first predetermined speed threshold and to a second predetermined speed threshold in order to determine whether this minimum speed is within the range of values determined by the first and second predetermined speed thresholds.

Also in step 24, the temperature gap is compared with a first predetermined temperature gap threshold.

If in step 24: either the minimum speed value is not between the first and second predetermined speed thresholds, or the temperature gap is below the temperature gap threshold, then the method proceeds to step 25.

In step 25 an event counter is set to zero. The precursor variable is also set to ‘False’.

If, on the contrary, in step 24: the minimum speed value is between the first and second predetermined speed thresholds, and the temperature gap is above the temperature gap threshold, then the method proceeds to step 26.

In step 26, a stored precursor value of the previous extended interval is retrieved. The stored value is representative of the previous occurrence (for example ‘True’) (or non-occurrence—for example ‘False’) of the double conditions observed in step 24 in the immediately previous extended interval. More particularly in a specific embodiment of the invention, the stored precursor value of the immediately previous extended interval is retrieved.

If in step 26, the stored precursor value is representative of the non-occurrence of the conditions of step 24 triggering step 26 in the previous extended interval (in this embodiment the precursor has the value ‘False’), then step 27 is implemented.

In step 27, the precursor value of the current extended interval being analyzed is set to be representative of the occurrence of the conditions of step 24 triggering step 26 in this extended interval; for example, it may be set to ‘True’.

Also in step 27, the event counter is set to 1.

If, in step 26, the stored precursor value is representative of the occurrence of the conditions of step 24 triggering step 26 in the previous extended interval (for example ‘True’), then step 28 is implemented.

In step 28, the event counter is set to a value above a predetermined threshold, for example the event counter may set to the value 2.

After step 27 or step 28, step 29 is implemented. In step 29, the value of the event counter is compared with an event threshold. The event threshold value may be 2 for example. If the event counter is equal or above the event threshold value, then step 30 is implemented.

Step 30 corresponds to the triggering of an alert signal. The alert signal may be a signal to a computer, for example an engine controller. The alert signal may also be a message to a human, such as a written message or a pilot light to a pilot, to a maintenance team or to a maintenance software for example. The alert signal may be representative of a degradation of the combustion conditions in the turbine engine. The alert signal and the moment at which it happened may be stored such that a history of the alert signal may be established for further analysis of its number and frequency of occurrence during an engine operation or even during multiple operation durations of the engine.

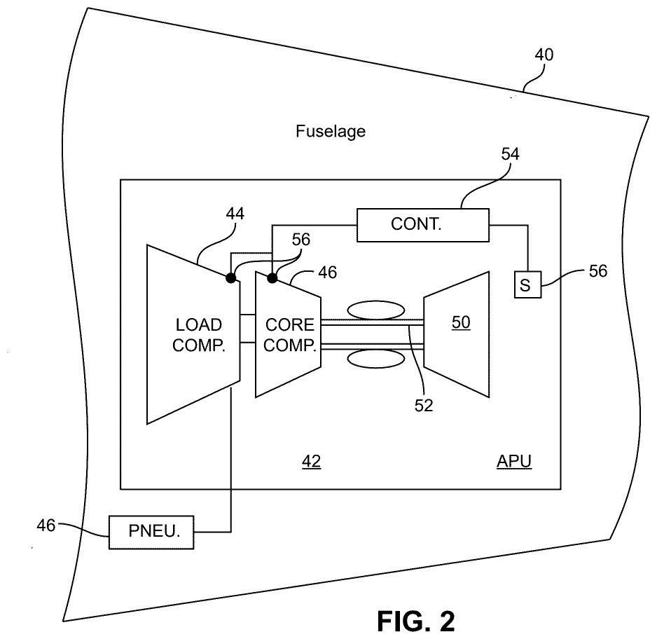

FIG. 2 shows schematically a tail portion of a fuselage 40 an aircraft within which is mounted in auxiliary power unit (APU) 42 which may be a gas turbine. The APU includes a load compressor 44 generating compressed air that is at least partially used to provide pressurized air for pneumatically driven components 46 in the aircraft, a core compressor 48 generating compressed air directed to a combustor 48 where the compressed air is mixed with fuel and burned. Combustion gases generated in the combustor drives a turbine 50 which turns a shaft 52 to drive the compressors 42, 44. A controller 54 monitors the APU such as by collecting temperature data of exhaust gases from sensors 56 downstream of the turbine. The controller executes the above described steps to detect a surge event and determine whether to trigger an alert signal or take further action such as to schedule maintenance or adjust a setting in the APU to avoid or reduce a surge event. The setting adjustment may be to actuate a bleed valve 56 on the load or core compressor.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for identifying surge events in a gas turbine engine comprising:
a. obtaining temperature values of exhaust gases of the engine at multiple instants during the operation of the engine,
b. obtaining values of a temperature variation indicator based on the temperature values,
c. determining a point in time when a first criteria and a second criteria are consecutively met, wherein the first criteria is at least one temperature value above a predetermined exhaust temperature threshold and the second criteria is at least one value of the temperature variation indicator above a first predetermined temperature variation threshold, and in response to the determination of the point in time in step c:
c i. defining a monitoring interval extending from the point in time and continuing until while the first criteria and the second criteria are consecutively met,
c ii. obtaining a set of values of rotation speeds of a shaft of the gas turbine engine during the monitoring interval, determining a minimum speed value of the rotational speeds in the set of values and comparing the minimum speed value to a first predetermined speed threshold,
c iii. obtaining a set of values of the temperatures of exhaust gases during the monitoring interval, calculating a temperature gap between a highest temperature value in the set of values and a lowest temperature value in the set of values, and comparing the temperature gap with a first predetermined temperature gap threshold, wherein steps c, ci, cii and cii are repeated, and
d. issuing an alert signal if the minimum speed value is below said first predetermined speed threshold and the temperature gap is above said predetermined temperature gap threshold during two of the monitoring intervals.

2. The method according to claim 1, where the alert signa is issued in response to the minimum speed, if the two monitoring intervals are consecutive.

3. The method according to claim 1, wherein the step c is implemented in response to the temperature variation indicator being below a second predetermined temperature variation threshold.

4. The method according to claim 1, wherein in step c, the monitoring interval is extended to include an interval immediately before the point in time when the first criteria and the second criteria are met.

5. The method according to claim 1, wherein in step c, the monitoring interval is extended to include an interval immediately following when the first criteria and the second criteria being met in the monitoring interval.

6. The method according to claim 4, wherein the monitoring interval is extended by a range of 2 to 30 seconds.

7. The method according to claim 1, wherein in step d, the alert signal is issued in response to the minimum speed value being above a second predetermined speed threshold.

8. The method according to claim 1, wherein the issuing of the alert includes at least one of: adjusting a fuel flow to a combustor of the gas turbine engine, reducing a load being driven by a compressor of the gas turbine engine, or adjusting inlet guide vanes on the gas turbine engine.

9. A computer-implemented method for identifying surge events in a gas turbine engine comprising:
a. obtaining temperature values of exhaust gases of the engine at multiple instants during the operation of the engine,
b. obtaining values of a temperature variation indicator based on the temperature values,
c. determining that a first criteria and a second criteria are consecutively met, wherein the first criteria includes at least one temperature value above a predetermined exhaust temperature threshold and a second criteria being at least one value of the temperature variation indicator being above a first predetermined temperature variation threshold, and in response to the determination that the first criteria and the second criteria are consecutive met:
c i. defining a monitoring interval extending from when the first criteria and the second criteria are consecutively met and continuing for a period while the first criteria and the second criteria are consecutively met,
c ii. obtaining a set of speed values of a rotation speed of a shaft of the gas turbine engine during the monitoring interval, determining the minimum value in the set of speed values, and comparing the minimum speed value to a first predetermined speed threshold,
iii. obtaining a set of temperature values of the temperatures of the exhaust gases during the monitoring interval, calculating a temperature gap between a highest temperature value in the set of temperature values and a lowest temperature value in the set of temperature values, and comparing the temperature gap with a first predetermined temperature gap threshold, and repeating steps c, ci, cii and ciii for at least two separate monitoring intervals, and
d. issuing an alert signal in response to during the at least two separate monitoring intervals the minimum speed value is below the first predetermined speed threshold and the temperature gap is above the predetermined temperature gap threshold.

10. The computer-implemented method according to claim 9, further comprising obtaining a set of values of a rotational speed of a shaft of the gas turbine engine and obtaining the set of temperature values of the temperature of exhaust gases from an electronic memory.

11. The computer-implemented method according to claim 9, further comprising for each time the minimum speed value is below said predetermined speed threshold and the temperature gap is above said predetermined temperature gap threshold, incrementing a counter and issuing the alert signal if the counter reaches 2.

12. The computer-implemented method according to claim 11, further comprising for each time the minimum speed value is above said predetermined speed threshold or the temperature gap is below said predetermined temperature gap threshold during the whole monitoring interval, resetting the counter to zero.

13. The computer-implemented method according to claim 9, wherein the issuing of the alert includes at least one of: adjusting a fuel flow to a combustor of the gas turbine engine, reducing a load being driven by a compressor of the gas turbine engine, or adjusting inlet guide vanes on the gas turbine engine.

14. A computer program comprising instructions for implementing the method of claim 1 when said computer program is run on a computer within an aircraft on which the gas turbine engine is mounted.

15. A method to detect and act on a surge event in a gas turbine, the method comprising:
obtain in real time temperature data from sensors monitoring gases flowing through or being exhausted from the gas turbine, wherein the temperature data is includes temperatures indicating a gas temperature and a time of the temperature;
determining a temperature of the gases and variations of the temperature of the gases based on the temperature data;
detecting as a first criteria a gas temperature of the gases exceeding an exhaust temperature threshold, and as a second criteria a temperature variation exceeding temperature variation threshold;
defining successive monitoring intervals between when a first instant of the first criteria or the second criteria are both met, continuing while the first criteria and the second criteria are consecutively met and ending when the first criteria and the second criteria are not consecutively met;
obtaining a set of values of a rotation speed of a shaft of the engine during each of the monitoring intervals, determining the minimum value in this set of values, and comparing this minimum speed value to a first predetermined speed threshold,
obtaining a set of temperature values of the temperature of exhaust gases during each of the monitoring intervals, calculating a temperature gap between a highest temperature value in the set of temperature values and a lowest temperature value in the set of temperature values, and comparing the temperature gap with a first predetermined temperature gap threshold, and
issuing an alert signal if, during two of the monitoring intervals, the minimum speed value is below said first predetermined speed threshold and the temperature gap is above said predetermined temperature gap threshold, triggering an alert signal.

16. The method according to claim 15, wherein the issuing of the alert includes at least one of: adjusting a fuel flow to a combustor of the gas turbine engine, reducing a load being driven by a compressor of the gas turbine engine, or adjusting inlet guide vanes on the gas turbine engine.

17. The method according to claim 15, where the alert signa is issued in response to the minimum speed, if the two monitoring intervals are consecutive.
